(19) United States
(12) Patent Application Publication
(10) Pub. No.: US 2009/0122721 A1
(43) Pub. Date: May 14, 2009

(54) HYBRID NETWORK DISCOVERY METHOD FOR DETECTING CLIENT APPLICATIONS

(76) Inventors: Kyoung-Hee Ko, Incheon (KR); Won-Tae Sim, Seongnam-si (KR); Woo-Han Kim, Seoul (KR)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 11/941,203

(22) Filed: Nov. 16, 2007

(30) Foreign Application Priority Data
Oct. 12, 2007 (KR) 10-2007-0102882

(51) Int. Cl. H04L 12/26

(52) U.S. Cl. 370/254

(57) ABSTRACT

A hybrid network discovery method for detecting client applications. The method has the steps of: (a) applying test traffic packets to a network which is to be measured, and analyzing responses so as to check target nodes; (b) transmitting a protocol request packet to each of the checked target nodes; and (c) when the URL of the header of the protocol request packet coincides with a site for a specific application of the target node, extracting the URL and the IP address of the target node.

### CROSS-REFERENCE TO RELATED APPLICATION

This application claims all benefits of Korean Patent Application No. 10-2007-0102882 filed on Oct. 12, 2007 in the Korean Intellectual Property Office, the disclosures of which are incorporated herein by reference.

### BACKGROUND OF THE INVENTION

1. Field of the Invention

The present invention relates to a hybrid network discovery method for detecting client applications, and more specifically, to a hybrid network discovery method for detecting client applications, in which an active network discovery method and a passive network discovery method are combined so as to detect client applications as well as server applications.

2. Description of the Prior Art

Security vulnerabilities are analyzed depending on IT asset information, and countermeasures are prepared on the basis of the analysis result of security vulnerabilities. Therefore, it is important for security managers to grasp how many servers, desktop computers, and network equipments are present on a network. Further, it is important to grasp which kinds of services and applications are being executed in each server.

However, it is not easy to automatically or manually collect and manage IT asset information. Further, as a network changes continuously, a change such as addition of host or service or a change in the version of an operating system needs to be detected during the network traffic measurement.

A network traffic discovery technique is roughly divided into an active discovery scheme and a passive discovery scheme.

In the active discovery, ICMP, TCP, UDP or ARP packets are transmitted to a target system, and response packets are analyzed so as to check the target system. When the active discovery is performed, scan may be interrupted by security devices such as firewalls, and so on, and an intrusion detection alarm may be triggered.

In the passive discovery, while network traffic is monitored, packets are analyzed as in an IDS (Intrusion Detection System). In the passive discovery, network services executed on non-default ports and network elements behind a fire wall can be detected. In the passive discovery, however, it is impossible to detect services and applications which are not used.

### SUMMARY OF THE INVENTION

An advantage of the present invention is that it provides a hybrid network discovery method for detecting client applications, in which an active network discovery method and a passive network discovery method are combined so as to detect client applications as well as server applications.

According to an aspect of the invention, a hybrid network discovery method for detecting client applications includes the steps of: (a) applying test traffic packets to a network which is to be measured, and analyzing responses so as to check target nodes; (b) transmitting a protocol request packet to each of the checked target nodes; and (c) when the URL of the header of the protocol request packet coincides with a site for a specific application of the target node, extracting the URL and the IP address of the target node.

The hybrid network discovery method may further include the step of: when a user-agent field of the protocol request packet header coincides with a user-agent of the specific application, extracting the user-agent.

The protocol request packet may be an HTTP request packet.

The specific application may be ActiveX control.

Further, step (a) includes the steps of: receiving a start message from an NDM (Network Data Mover) control; at an NDM agent, reading configuration and input files; at an Nmap interface, generating an Nmap input file so as to execute an Nmap program; outputting the execution result in the form of XML; transmitting SNMP (Simple Network Management Protocol) queries to the respective target nodes through an SNMP interface; and analyzing SNMP responses so as to check the target nodes.

### BRIEF DESCRIPTION OF THE DRAWINGS

The above and other objects, features and advantages of the present invention will be more apparent from the following detailed description taken in conjunction with the accompanying drawings, in which:

FIG. 1 is a flow chart showing a hybrid network discovery method for detecting client applications according to an embodiment of the present invention;

FIG. 2 is a flow chart showing active network discovery; and

FIG. 3 is a block diagram showing the structure of a TCP/IP packet.

### DETAILED DESCRIPTION OF EMBODIMENTS

Hereinafter, a hybrid network discovery method for detecting client applications according to an embodiment of the present invention will be described with reference to the accompanying drawings.

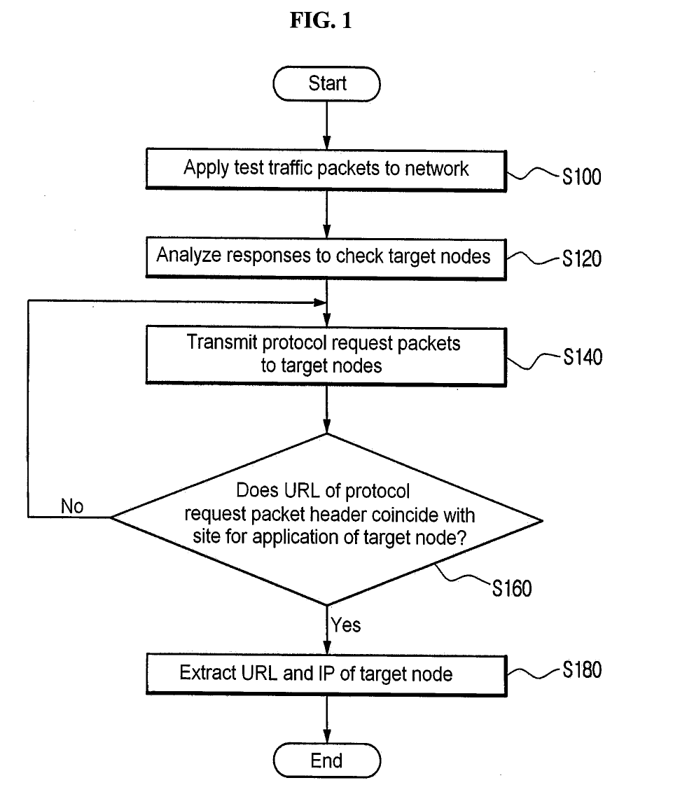

FIG. 1 is a flow chart showing a hybrid network discovery method for detecting client applications according to an embodiment of the invention.

Referring to FIG. 1, arbitrary test traffic packets are applied to a network which is to be measured, in order to perform active network discovery (step S100). Further, responses to the test traffic packets are analyzed so as to measure traffic characteristics such as delay between terminals, loss ratio, delay variation, and so on and target nodes are checked (step S120). Accordingly, it is possible to check whether a client computer exists on the network or not.

For the active network discovery, an NDM (Network Data Mover) agent can use an Nmap (Network Mapper) and an SNMP (Simple Network Management Protocol), for example. The Nmap, which is a utility for network security, is a tool for quickly scanning a large-scale network. Using raw IP packets, the Nmap assesses various characteristics of the network, such as which hosts are alive in the network, what services (ports) the hosts provide, which operating systems (OS version) are installed in the hosts, what is the packet type of a filter/firewall, and so on.

The SNMP (Simple Network Management Protocol), which is a network management protocol of TCP/IP, is a standard communication protocol which is used for transmitting network management information of network devices, such as routers or hubs, to a network management system. The SNMP uses two functions of request and response so as to collect and manage network management information.

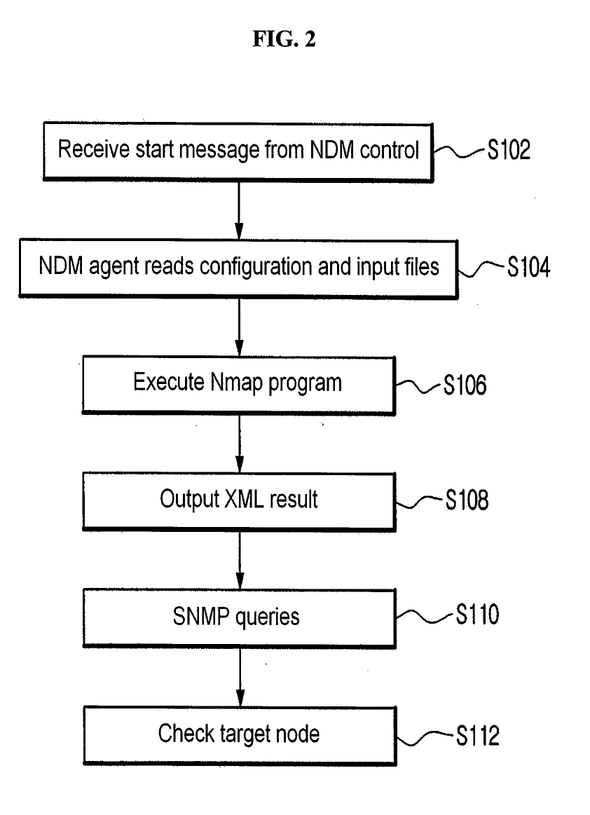

FIG. 2 is a flow chart showing the active network discovery.

Referring to FIG. 2, a start message is received from an NDM control (step S102), and an NDM agent reads configuration and input files (step S104). The configuration and input files are generated when an NDM config receives a configuration message from the NDM control. The input files include the IP addresses of target hosts.

Continuously, an Nmap interface generates Nmap input files and executes an Nmap program (step S106). A default Nmap option is TCP and UCP scan in which an operating system can be detected. The Nmap outputs a result in the form of XML (step S108).

The result of the Nmap includes an IP address, a host name, the name and version of an operating system, open ports, protocols, the state of each port, services, the version of each service, and so on. The NDM agent transmits SNMP queries to the respective target nodes through the SNMP interface (step S110) so as to check the target nodes (step S112).

Returning to FIG. 1, in order to perform passive network discovery, protocol request packets are transmitted to the checked target nodes so as to check whether client applications are operated or not (step S140).

Tools used for the passive network discovery are not specifically limited. For example, Ettercap, nTop, p0f, and so on can be used. A result of the passive network discovery includes an IP address, the name and version of an operating system, open ports, protocols, services, the version of each service, and so on. The Ettercap uses a signature matching technique with a packet header such that the version in the operation system and passive mode can be checked.

The types of applications to which the passive network detection is applied are not specifically limited. For the purpose of illustration, HWP as a word processor, GOM player as a media player, ALZip as a compression utility, and NateOn as a messenger program are selected and described.

The above-described applications excluding NateOn have no open port and are connected to the Internet through the HTTP protocol. The HTTP protocol is a TCP protocol using port 80. In general, the connection of the HTTP protocol is allowed in most firewalls.

Further, the applications provide an automatic or manual update function through the HTTP protocol. The ALZip provides an advertisement screen through the HTTP protocol, and the GOM player provides functions of downloading media files and searching subtitle files and codecs through the HTTP protocol.

The ALZip, the GOM player, and the NateOn have a specific string in a user-agent field of an HTTP request packet.

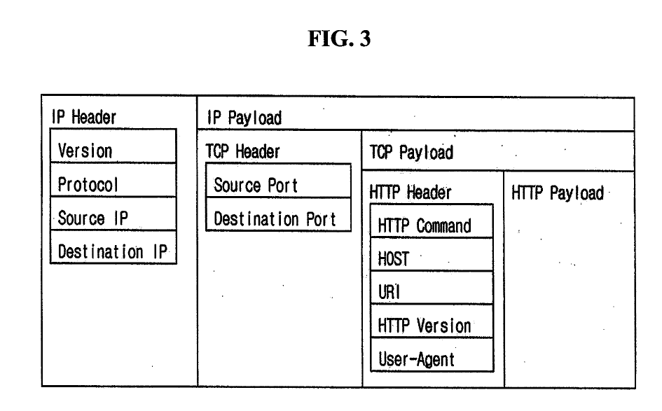

FIG. 3 is a block diagram showing the structure of a TCP/IP packet. An HTTP header includes information on HTTP command, host, URI, HTTP version, and user-agent.

Returning to FIG. 1, after the protocol request packet is transmitted to the checked target node, and when the URL of the protocol request packet header coincides with a site for the application of the target node (step S160), the URL and the IP address of the target node (the source IP address in FIG. 3) are extracted (step S180). The URL indicates the locations of files stored in each server which provides a service on the web, and includes the type of a service which is to be connected, the location (domain name) of a server, and the location of a file. Through the extraction, it is possible to check the target node to which a specific application is applied.

Now, the above-described process will be examined for the HWP, the GOM player, the ALZip, and the NateOn, respectively, which have been described as examples of the applications. When a URL of the HTTP request packet header, which is a combination of a host and a URI field, coincides with a HWP update site, the source IP address and the URL are extracted. Further, when a URL of the HTTP request packet header coincides with an ALZip advertisement URL, the source IP address and the URL are extracted. Furthermore, when a URL of the HTTP request packet header coincides with GOM download media and search subtitles/codec URL, the source IP and the URL are extracted.

When the user-agent field of the protocol request packet header coincides with a user-agent of the specific application, the user-agent of the protocol request packet header is further extracted so as to perform network discovery. That is, when the URL of the HTTP request packet header coincides with each update site of the ALZip/GOM player/NateOn and the user-agent field coincides with the user-agent of the ALZip/GOM player/NateOn, the source IP address, the URL, and the user-agent are extracted. Further, when the user-agent field of the HTTP request packet header coincides with the user-agent of GOM/NateOn, the source IP address and the user-agent are extracted.

Hereinafter, the detection of ActiveX Control applications in the Internet Explorer of Microsoft, which is a web browser among client applications, will be described in detail.

The detection of ActiveX control can be divided into a first detection in which a source IP address and a user-agent are extracted from an HTTP request packet header, a second detection in which a source IP address, a class ID, and codebase are extracted from an HTTP response packet payload, and a third detection in which a source IP address and a URL including “.cap” or “.ocx” are extracted from an HTTP request packet header. Table 1 shows the situations where ActiveX control is likely to be detected.

TABLE 1

| | |
|---|---|
| 1 | The case where ActiveX is already installed without necessity for |
| | requesting ActiveX |
| 2 | The case where ActiveX is installed after ActiveX is requested in a |
| | browser |
| 3 | The case where ActiveX is installed by directly inputting a URL |
| 4 | The case where ActiveX is downloaded by directly inputting a URL, |
| | but is not installed in a browser because of security configuration and |
| | the selection of a user |
| 5 | The case where ActiveX is requested in a browser, but is not installed |
| | because of security configuration or the selection of a user |
| 6 | The case where a browser does not request ActiveX because of |
| | security configuration |
| 7 | The case where a browser does not support ActiveX |

The ActiveX control is supported by Microsoft Internet Explorer. Therefore, when a user-agent is not Microsoft Internet Explorer, it is not likely that the ActiveX control is detected. Accordingly, the case 7 is not considered any more.

In the cases 1 and 6 where the user-agent extracted in the first detection is Microsoft Internet Explorer, a HTTL code of <object classid=xxx codebase=yyy . . . > is included in a response packet payload sent by a web server in the second detection. However, there is no additional HTTP request such as URL codebase yyy of the third detection. The above-described situation occurs when classid xxx ActiveX control is already installed in a client system such that the installation of ActiveX control does not need to be requested (case 1), or when the corresponding ActiveX control is not installed by the security configuration or the selection of a user (case 6).

In the cases 2 and 5 where the user-agent extracted in the first detection is Microsoft Internet Explorer, an HTML code of <object classid=xxx codebase=yyy . . . > is included in a response packet payload sent by a web server in the second detection. Further, there is an additional HTTP request such as URL codebase yyy of the third detection. The above-described situation may occur when ActiveX control of which the classid is xxx is installed (case 2), or when the corresponding ActiveX control is not installed because of security configuration or the selection of a user even though an installation file is downloaded (case 5).

In the cases 3 and 4 where the user-agent extracted in the first detection is Microsoft Internet Explorer, there is an additional HTTP request such as URL codebase yyy of the third detection. In this case, however, a web server does not send a response packet including an HTTP code of <object classid=xxx codebase=yyy . . . >, unlike the second detection. The above-described situation may occur when a user directly downloads an installation file of ActiveX control to install (case 3) or when the corresponding ActiveX control is not installed because of security configuration or the selection of a user even though the installation file is downloaded (case 4).

According to the hybrid network discovery method for detecting client applications, the active network discovery method and the passive network discovery method are combined so as to detect whether a target node exist or not and the characteristic of the target node.

Further, the IT asset information collected by the hybrid network discovery method can be used for a vulnerability scanner, risk analysis, and so on in a frame work.

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

What is claimed is:

1. A hybrid network discovery method for detecting client applications, comprising the steps of:
(a) applying test traffic packets to a network which is to be measured, and analyzing responses so as to check target nodes;
(b) transmitting a protocol request packet to each of the checked target nodes; and
(c) when the URL of the header of the protocol request packet coincides with a site for a specific application of the target node, extracting the URL and the IP address of the target node.

2. The hybrid network discovery method according to claim 1 further comprising the step of:
when a user-agent field of the protocol request packet header coincides with a user-agent of the specific application, extracting the user-agent.

3. The hybrid network discovery method according to claim 1, wherein the protocol request packet is an HTTP request packet.

4. The hybrid network discovery method according to claim 1, wherein the specific application is ActiveX control.

5. The hybrid network discovery method according to claim 1, wherein step (a) includes the steps of:
receiving a start message from an NDM (Network Data Mover) control;
at an NDM agent, reading configuration and input files;
at an Nmap interface, generating an Nmap input file so as to execute an Nmap program;
outputting the execution result in the form of XML;
transmitting SNMP (Simple Network Management Protocol) queries to the respective target nodes through an SNMP interface; and
analyzing SNMP responses so as to check the target nodes.
